(19) United States
(12) Patent Application Publication
(10) Pub. No.: US 2003/0121506 A1
(43) Pub. Date: Jul. 3, 2003

(54) Economiser for combustion devices

(76) Inventor: Ivana Ferrara, Misano Adriatico (IT)

Correspondence Address: ABELMAN, FRAYNE & SCHWAB, Attorneys at Law, 150 East 42nd Street, New York, NY, 10017, US

(21) Appl. No.: 09/923,473

(22) Filed: Aug. 6, 2001

(30) Foreign Application Priority Data
Aug. 7, 2000 (IT) FI2000A000178

(51) Int. Cl. F02M 27/00; B03C 1/30; B03C 1/02

(52) U.S. Cl. 123/538; 210/222; 210/748; 431/356

(57) ABSTRACT

An economiser for combustion devices, consisting of a preferably steel tube around which at least two coils set side by side are wound, said coils being traversed by electric current and being capable of inducing an electromagnetic field inside the tube. The coils are enclosed in a preferably metal casing and then possibly resin-potted. The device is preferably designed for improving combustion in engines, boilers, and burners in general.

### FIELD OF THE INVENTION

The present invention relates to the sector of apparatus designed for the optimisation of the efficiency of engines for motor vehicles, and more in general of combustion devices, such as internal-combustion engines, boilers, burners, etc.

### STATE OF THE ART

At present, a strong need is felt to improve the combustion of engines for motor vehicles, as well as the combustion in boilers for domestic use, both for reasons of an economic and technical nature and for environmental reasons.

More in general, in view of the widespread use of combustion devices, reducing emission of pollutant gases, at the same time still benefiting from the efficiency and high degree of reliability of currently available devices, is a target of considerable interest.

### OBJECT OF THE INVENTION

A first purpose of the present invention is to propose an economiser which is able to increase sensibly the efficiency of combustion in internal-combustion engines, both ones running on petrol (either leaded or unleaded petrol) and ones supplied with gas oil or gas.

A second purpose is to provide an economiser for combustion devices which is simple to apply and does not involve operations that may adversely affect the safety of the pre-existing system, and in particular the guarantees provided by the manufacturer.

### SUMMARY OF THE INVENTION

The above purposes are achieved by an economiser for a combustion device, consisting of a preferably steel tube around which at least two coils are wound, which are traversed by an electric current and are capable of inducing electromagnetic fields inside the tube, with the combined effect of improving the behaviour of the molecules of the fuel in the subsequent combustion stage.

The coils are enclosed in a preferably metal casing, and then are closed at the sides and possibly potted using a resin compound.

In preferred embodiments, four coils are used that are supplied with 12-V direct current, and the potting compound used is a quartz resin.

Anyway, alternate current with either constant or varying frequency can also be utilised.

Furthermore, said coils can be independently removable to be added or substituted to the device.

Preferably, the internal tube is designed to house the feed pipe for the fuel (petrol, gas oil, gas) in such a way that it is traversed by the feed pipe, but it is also possible to envisage, in particular for applications in gas boilers for domestic use, the use of joints at the ends of the tube, to which the corresponding ends of the gas-feed pipe are connected.

The device is powered by a power unit/units, not shown in the drawings. Furthermore, the power unit/units are possibly capable of supplying each or part of the coils in an independent manner.

The advantages achieved will emerge clearly from the ensuing description and from the annexed drawings, which are provided by way of non-limiting example.

### LIST OF DRAWINGS

By way of non-limiting example,

FIG. 1 is a side view of a device according to the invention;

FIGS. 2a and 2b respectively show a cross-sectional view and a front view of a first plug of the device of FIG. 1;

FIGS. 3a and 3b respectively show a cross-sectional view and a front view of a second plug of the device of FIG. 1;

FIG. 4 is a side view of a second embodiment of a device according to the invention;

FIGS. 5a and 5b respectively show a cross-sectional view and a front view of a first plug of the device of FIG. 4; and

FIG. 6 is a cross-sectional view of a second plug of the device of FIG. 4.

### DETAILED DESCRIPTION OF THE INVENTION

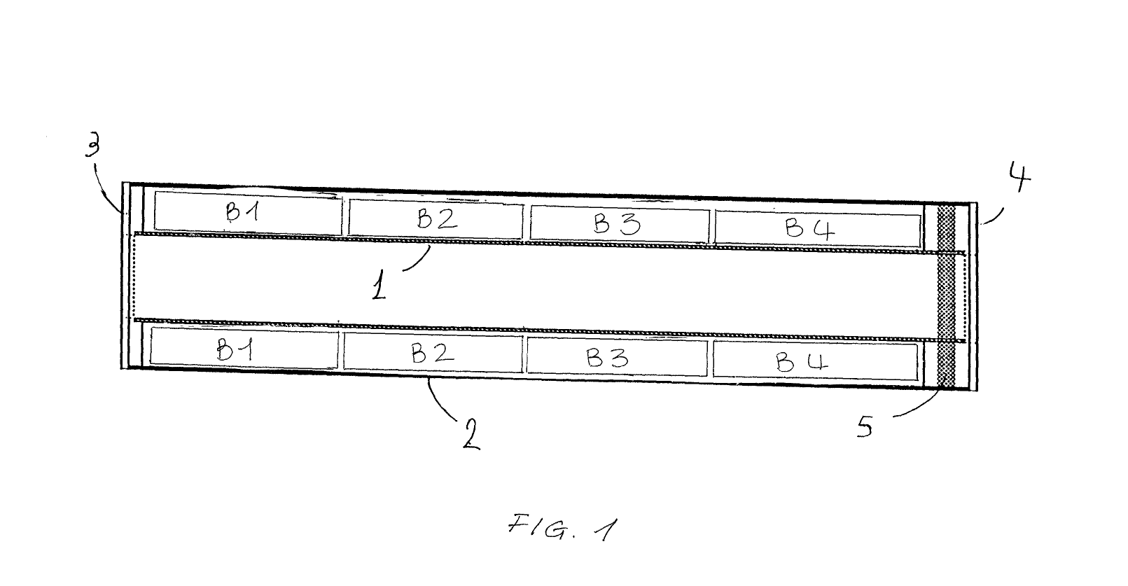

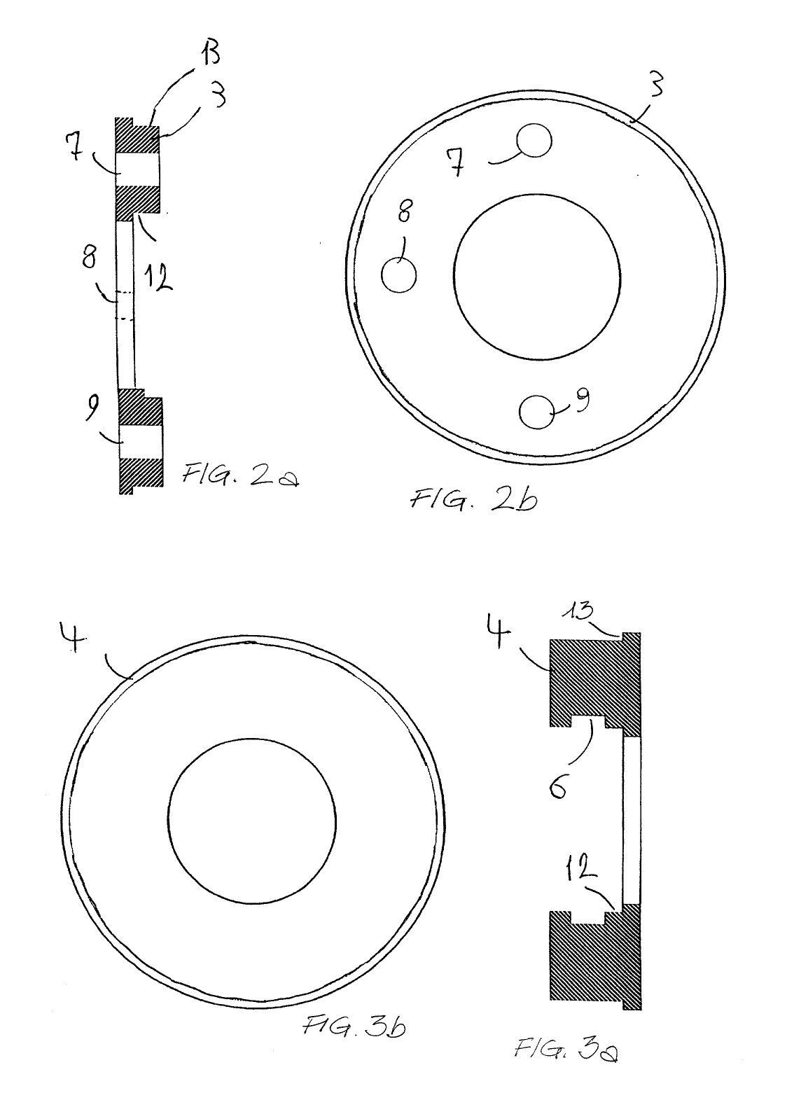

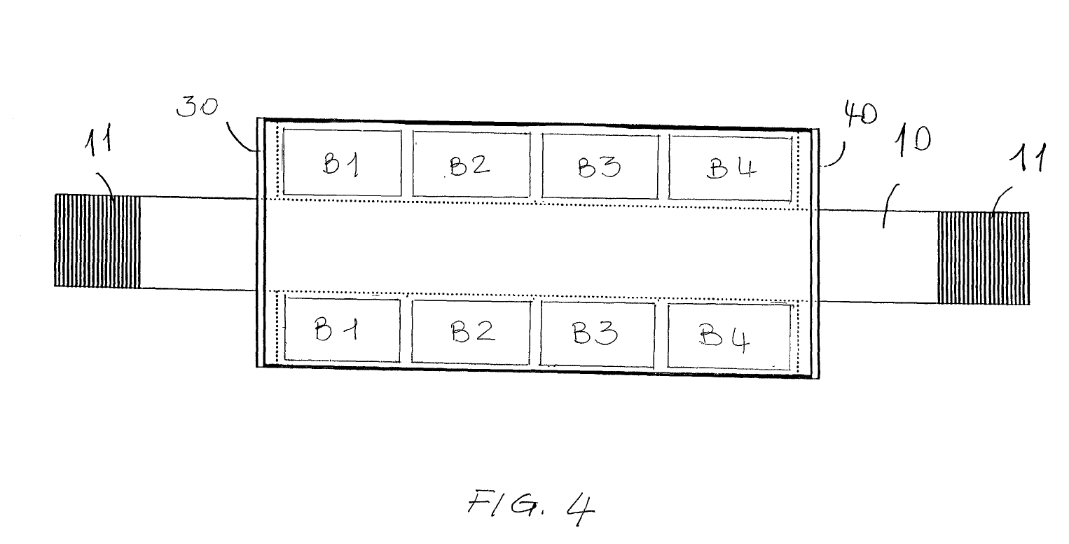

With reference to FIGS. 1-3, a preferred embodiment of an economiser according to the invention, particularly suited for use in motor vehicles, is described in what follows.

The economiser consists of a metal tube 1, preferably made of high-carbon steel, around which four coils B1-B4 are wound, which are connected to a DC electric power supply, preferably a 12-V supply.

The connection of the coils to the electric power supply is not illustrated in the figures in so far as it is of a known type.

The coils B1-B4 are then enclosed in a metal casing 2, which is also preferably made of high-carbon steel, and are contained laterally by a first plug 3 and a second plug 4, which have the shape of an annulus and are both provided with a seat 12 for ensuring stable housing for the ends of the tube 1, and with a seat 13 for ensuring stable housing for the ends of the casing 2.

The plug 3 is moreover provided with three holes 7, 8, 9, one of which is designed for enabling introduction of a potting compound, preferably a quartz or silicone resin, inside the device in the gap between the tube 1 and the casing 2, another hole is designed to house a LED, and yet another to enable passage of the power-supply cable.

Advantageously, introduction of the potting compound makes it possible to compact and protect the device and to dissipate with greater efficiency the heat produced by the windings.

It is anyway obvious that other cooling methods can be used, as well as that said LED can be placed in a different location, for example on a power unit of the device.

Finally, the plug 4 is provided with a seat 6 for housing a seal 7, preferably an O-ring, which is designed to ensure tightness with the tube 1 so as to prevent the potting compound from coming out at the moment of filling.

In operation, the end of the fuel-feed pipe coming out of the fuel tank is made to pass inside the tube 1, and its original connection is restored.

The coils are then connected to the electric power supply of the vehicle, and proper operation of the device is indicated by the LED lighting up.

When the vehicle is in motion, the fuel passing inside the device is subjected to the action of the magnetic fields induced by the coils B1-B4, which improve the quality of the subsequent combustion, with the consequence of an increase in high heat value and a decrease in CO and HC emission.

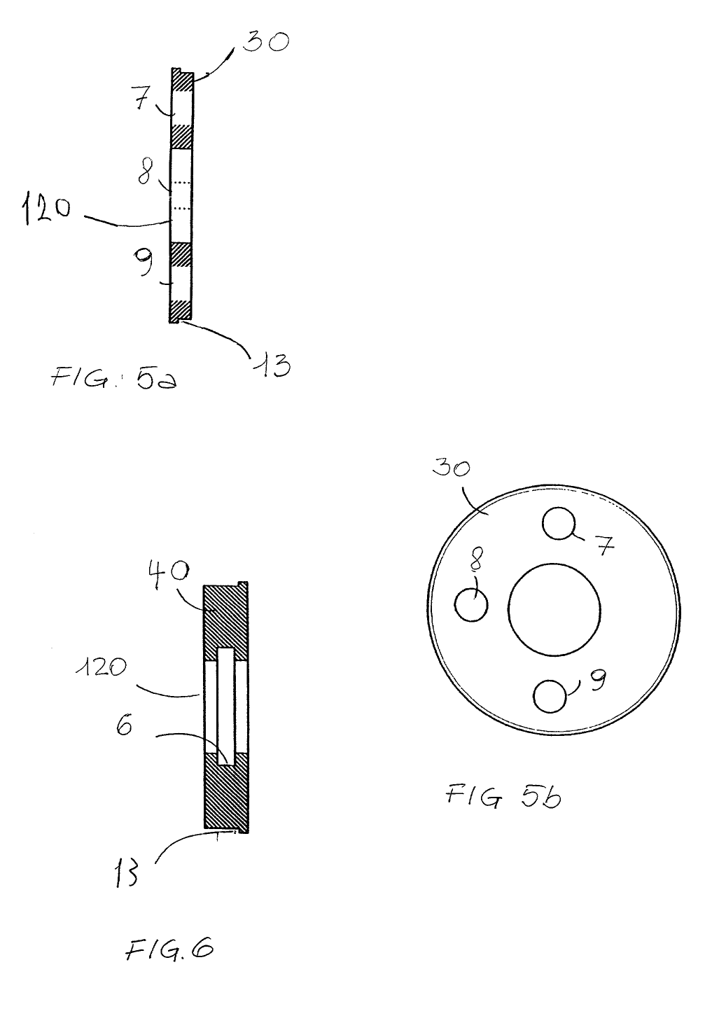

FIGS. 4-6 represent another embodiment of the device, which is particularly suited for improving the efficiency of gas combustion in burners of cookers and/or domestic heating systems. In FIGS. 4-6 the numbers corresponding to those of FIGS. 1-3 refer to equivalent parts.

In the present case, the internal tube of the device is a through tube 10 provided, at its ends, with a gas thread 11 for connection to the gas pipe, of the type used, for example, in a domestic heating plant, and in each of the plugs 30, 40, which are annular in shape, a seat 120 is made for passage of the tube 10.

It is evident that different connections, for examples flanged joints, can be used instead of the described gas threads.

The table below presents some of the results obtained in systems provided with the economising device (fuel feed pipe made of rubber or metal), and the results are compared with those of the combustion in the same system without the device according to the invention.

TABLE I

| | | High heat value |
|---|---|---|
| Fuel | Treatment | (kcal/kg) |
| Unleaded petrol | without economiser | 10.111 |
| Unleaded petrol | rubber pipe | 10.580 |
| Unleaded petrol | metal pipe | 10.728 |
| Leaded petrol | without economiser | 11.197 |
| Leaded petrol | rubber pipe | 10.876 |
| Leaded petrol | metal pipe | 10.111 |
| Gas oil | without economiser | 10.506 |
| Gas oil | rubber pipe | 11.345 |
| Gas oil | metal pipe | 10.975 |

Table II below gives the CO and CH emission from an automobile supplied with unleaded petrol, both in the case where the vehicle was equipped with the economiser according to the invention and when it was not, for different engine-running rates.

TABLE II

| | CO emission | HO emission |
|---|---|---|
| Engine r.p.m | (% by vol) | (ppm by vol) |
| minimum without economiser | 0.77 | 197 |
| minimum with economiser | 0.06 | 40 |
| 2500 rpm without economiser | 0.95 | 83 |
| 2500 rpm with economiser | 0.06 | 18 |

1. An economizer for combustion devices, consisting of a preferably steel tube (1, 10) around which at least two coils set side by side are wound, through said coils electric current can flows and they are capable of inducing corresponding electromagnetic fields inside the tube (1, 10), where the coils are enclosed in a preferably metal casing (2).

2. The economizer according to claim 1, in which four coils (B1-B4) are provided which are supplied with direct current, and they are resin-potted by a potting compound made of a quartz or silicone resin.

3. The economizer according to claim 2, in which said tube (1) is designed to house the feed pipe for the fuel (petrol, gas oil, gas) in such a way that it is traversed by the feed pipe.

4. The economizer according to claim 1, in which at the ends of said tube (10) gas threads (11) are provided for connection of the corresponding ends of the gas-feed pipe.

5. The economizer according to claim 3 or claim 4, in which plugs (3, 4, 30, 40) are provided for closing the coils laterally.

6. The economizer according to claim 5, in which said plugs (3, 4) have the shape of an annulus and are both provided with a seat (12) for ensuring stable housing for the ends of the tube (1), and with a seat (13) for ensuring stable housing for the ends of the casing (2).

7. The economizer according to claim 6, in which the plug (3) is moreover provided with three holes (7, 8, 9), one of which is designed for enabling introduction of the resin-potting compound inside the device in the gap between the tube (1) and the casing (2), another hole is designed to house a LED, and yet another to enable passage of the power-supply cable.

8. The economizer according to claim 7, in which the plug (4) is provided with a seat (6) for housing a seal (7), preferably an O-ring, which is designed to ensure tightness with the tube (1) so as to prevent the resin-potting compound from coming out at the moment of filling.

9. The economizer according to claim 5, in which the tube (10) protrudes laterally from the casing (2) and is provided at its ends with threads (11) for connection to gas pipes.

10. The economizer according to claim 9, in which the plugs (30, 40) are annular in shape, and in each of them a seat (120) is made for passage of the tube (10), and said plug (40) is provided with a seat (6) for housing a seal (7), preferably an O-ring, which is designed to ensure tightness with the tube (10) so as to prevent the resin-potting compound from coming out at the moment of filling.

11. The economiser according at least one of the preceding claims, wherein said current is alternate current of constant or variable frequency.

12. The economiser according at least one of the preceding claims, wherein said coils are individually powered by one or more power unit/s.

13. The economiser according at least one of the preceding claims, wherein said coils are individually removable and replaceable from the device.
